(19) United States
(12) Patent Application Publication
(10) Pub. No.: US 2010/0242288 A1
(43) Pub. Date: Sep. 30, 2010

(54) Double-Pivot Folding Knife

(76) Inventor: Kenneth J. Onion, Kaneohe, HI (US)

Correspondence Address: HOLLAND & HART, 222 South Main Street, Suite 2200, P.O. Box 11583, Salt Lake City, UT, 84110, US

(21) Appl. No.: 12/415,943

(22) Filed: Mar. 31, 2009

(51) Int. Cl. B26B 1/04

(52) U.S. Cl. 30/160

(57) ABSTRACT

A folding knife having a handle, a blade pivotably coupled to the handle, and a liner includes a liner lock and a first pivot point that is a post, pin, rod, or other structure having a shape adapted to be slidably received in the second arcuate opening of the blade. The liner further includes a first arcuate opening that has an enlarged end portion and an axis approximately perpendicular to the longitudinal axis of the handle adapted for slidably receiving the second pivot point of the blade. A tang of the blade includes the second pivot point, and the second arcuate opening that has an enlarged end portion and an axis approximately parallel to the longitudinal axis of the blade. An extended tang portion, or flipper, extends downward from the tang. The handle also includes an opposing liner arranged alongside the liner in the handle with the blade positioned therebetween.

### BACKGROUND OF THE INVENTION

1. Technical Field

This invention pertains to cutlery and knives.

2. Description of the Related Art

FIG. 1 shows a typical fixed-blade knife 100, including a handle 102 and a blade 104. The length of the blade is shown at B₁, while the length of the handle is indicated at H₁. It can be seen that, in the example illustrated, the blade 104 is longer than the handle 102.

FIG. 2 shows a typical folding knife, including a handle 202 and a blade 204. A portion of the handle is shown transparently to show the tang of the blade and the pivot point 208 coupling the blade to the handle, and around which the blade 204 rotates to fold into the handle. It will be recognized that, in order for the blade to fold into the handle, the portion of the blade between the pivot point and the blade point, indicated at B₂, must be no longer than the portion of the handle between the pivot point 208 and the heel 205 of the handle, indicated at H₂. If B₂ were longer than H₂, the point of the blade would extend beyond the heel 205 of the handle 202 while the knife 200 was folded.

### BRIEF DESCRIPTION OF THE DRAWINGS

FIG. 1 is an illustration of a typical fixed blade knife.

FIG. 2 is an illustration of a typical folding knife.

FIG. 3 is an illustration of a certain embodiment of a folding knife of the present invention in the extended position.

FIG. 4 is an illustration of a certain embodiment of a folding knife of the present invention in the folded position.

FIG. 5 is an illustration of the components of a certain embodiment of a folding knife of the present invention.

FIGS. 6A-E are illustrations of a certain embodiment of a folding knife of the present invention in positions ranging from the folded position to the extended position.

FIGS. 7A-E are illustrations of another embodiment of a folding knife of the present invention in positions ranging from the folded position to the extended position.

FIGS. 8A-E are illustrations of another embodiment of a folding knife of the present invention in positions ranging from the folded position to the extended position.

FIGS. 9A-E are illustrations of another embodiment of a folding knife of the present invention in positions ranging from the folded position to the extended position.

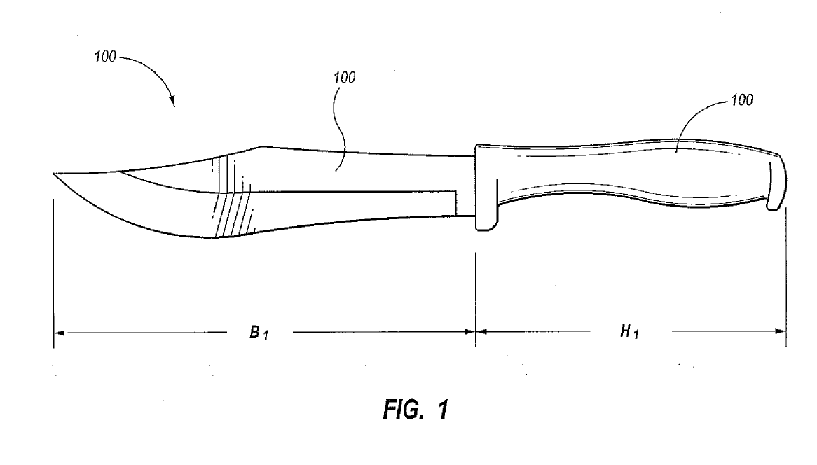

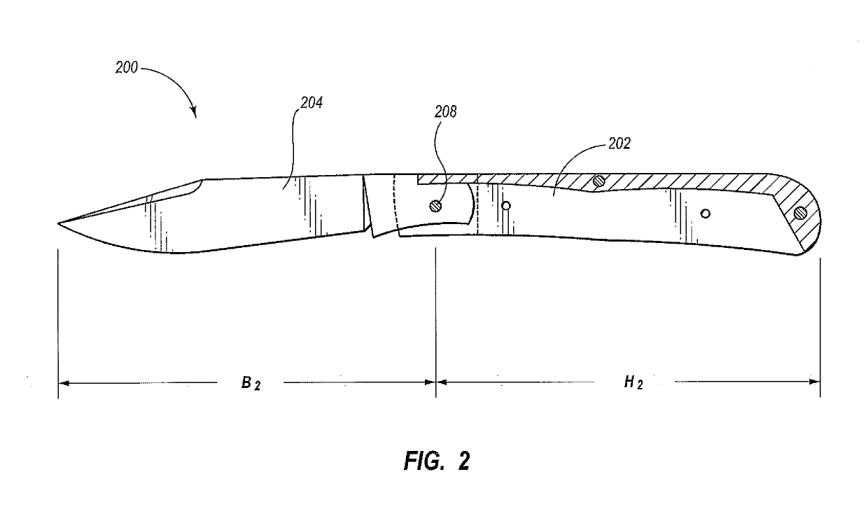

### DETAILED DESCRIPTION OF THE INVENTION

A limitation of prior art folding knives is that the length of the blade is limited by the length of the handle, in the relationship described in the background.

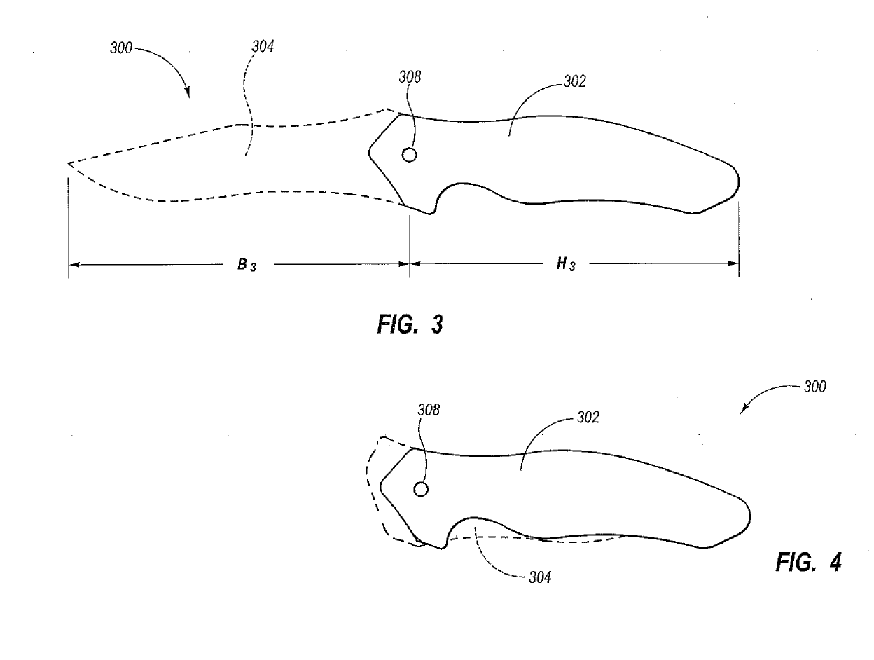

FIG. 3 shows a folding knife 300 according to an embodiment of the invention in the extended position, including a handle 302 and a blade 304 pivotably coupled to the handle 302. Comparing a length of the portion of the blade between a pivot point 308 and the blade point, indicated at B₃, with a length of the portion of the handle 302 between the pivot point 308 and the heel 305 of the handle, indicated at H₃, it can be seen that, in the pictured embodiment, B₃ is longer than H₃. FIG. 4 shows the folding knife 300 according to an embodiment of the invention in the folded position.

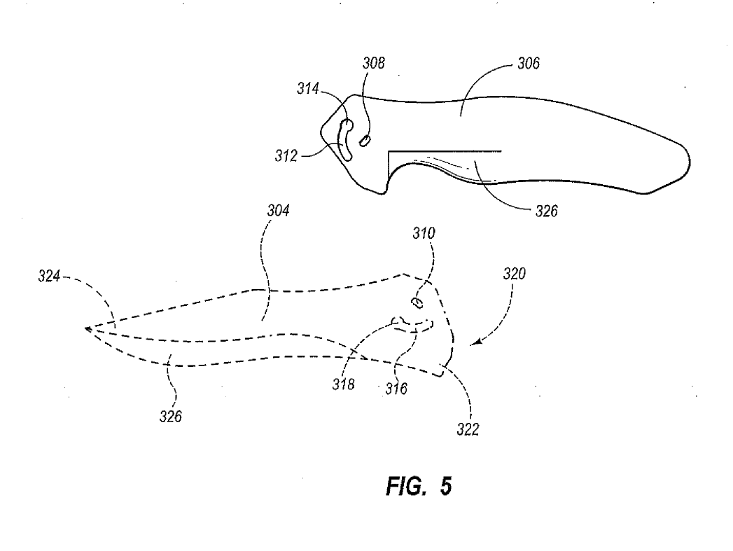

In the description of this and other embodiments, reference to pivot points will be substantially generic, i.e., a post, pin, rod, or other fixture having a shape of the pictured aperture is positioned in each aperture. Referring now to FIG. 5, a liner 306 portion of the handle 302, and blade 304 of the knife 300 are shown. The liner includes a liner lock 326 such as is known in the art. The liner also includes a first pivot point 308, that is a post, pin, rod, or other structure having a shape adapted to be slidably received in the second arcuate opening 316 of the blade 304. The liner further includes a first arcuate opening 312 that has an enlarged end portion 314 and an axis approximately perpendicular to the longitudinal axis of the handle. The first arcuate opening 312 is adapted for slidably receiving the second pivot point 310 of the blade 304.

A tang 320 of the blade 304 includes a second pivot point 310, and a second arcuate opening 316 that has an enlarged end portion 318 and an axis approximately parallel to the longitudinal axis of the blade. An extended tang portion, or flipper 322, extends downward from the tang 320 as shown in FIG. 5. The handle 302 also includes an opposing liner arranged alongside the liner 306 in the handle 302 with the blade 304 positioned therebetween. A backspacer or other means for holding the liners in a spaced-apart relationship is also included, though not shown herein. With the exception of the liner lock 326, features of the opposing liner are substantially identical to those described with reference to liner 306, and one of ordinary skill will understand the structure and operation of the folding knife 300 through a description of the structure and relationship of the liner 306 and blade 304.

The blade is shown in broken lines to assist in differentiating the blade from the liner in figures that follow. Where the features of the blade are small enough that details might be lost in broken lines, the features are shown in solid lines, while the leader lines from reference numbers are still broken. The first and second pivot points 308, 310 are represented in the figures as apertures formed in the respective components. It will be understood that a post, pin, rod, or other fixture having a shape of the pictured aperture is positioned in each aperture.

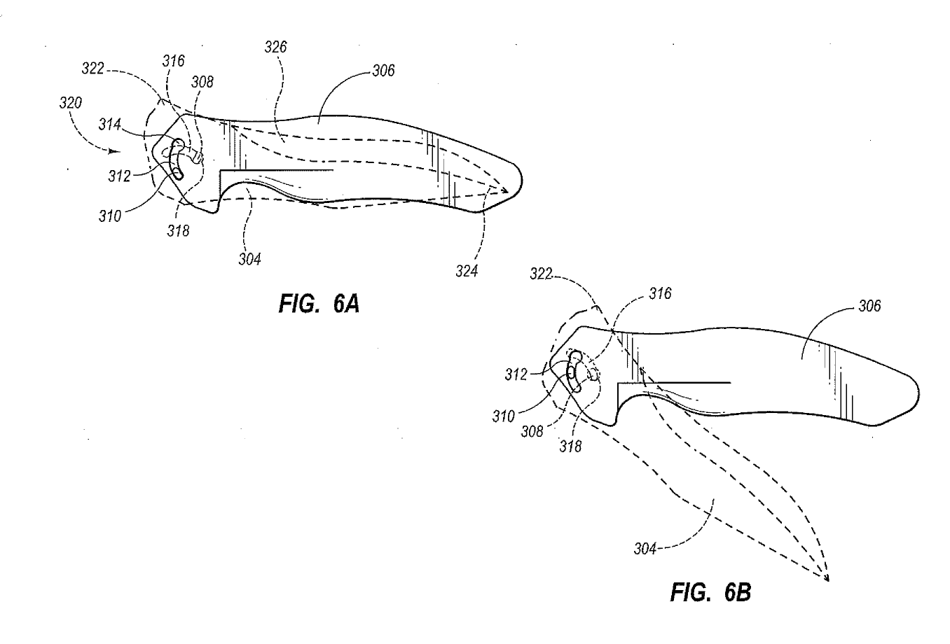

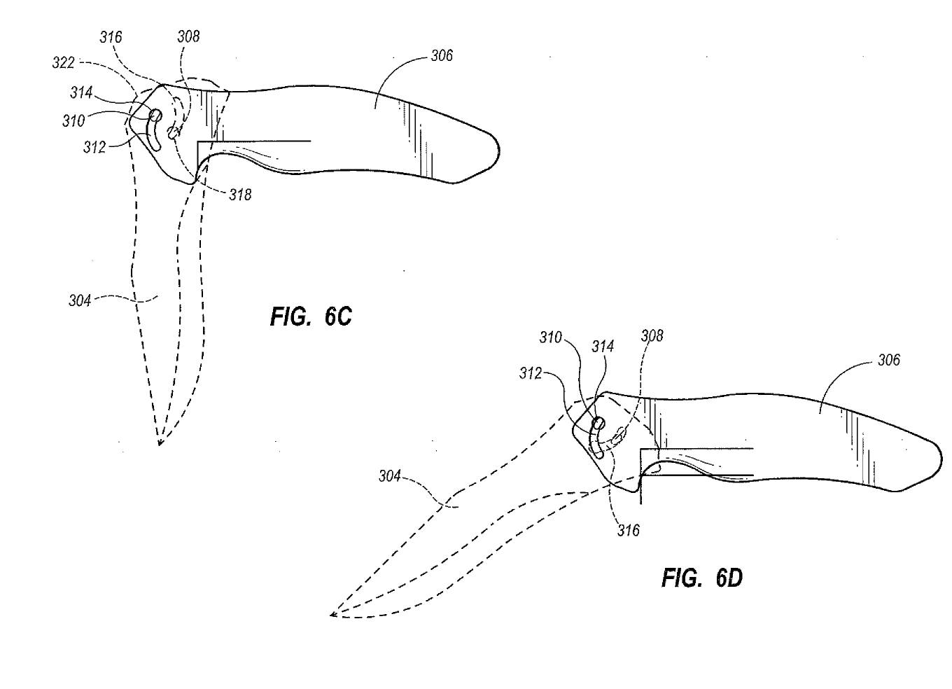

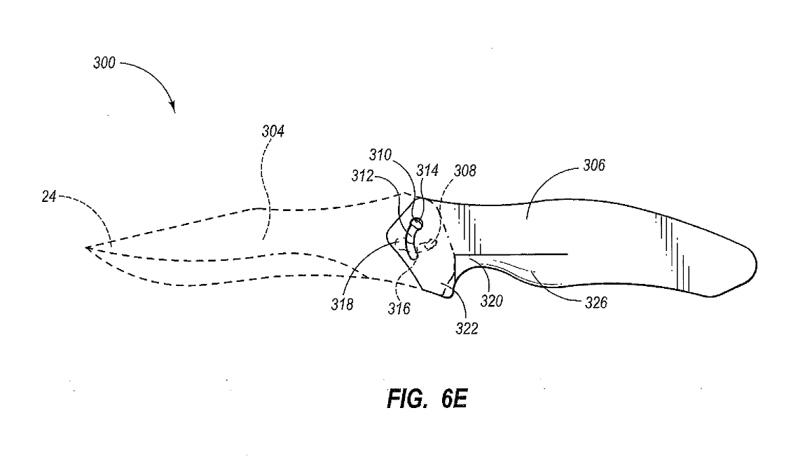

Turning now to FIG. 6A, the blade 304 is shown in the folded position relative to the liner 306. The first pivot point 308 extends between the liner 306 and the opposing liner and traverses the second arcuate opening 316 formed in the blade 304. The first pivot point 308 may also extend to the outside of the handle 302, and may have an enlarged head at one end, and threads at the other, to receive a nut or other fastener, in a manner known in the art. The second pivot point 310 extends outward from the blade 304 to the liners and engages the first arcuate opening 312. The first and second pivot points, 308 and 310, respectively, are shaped such that they can rotate only while positioned, respectively, in the enlarged end portions 318,-314 of the second and first arcuate openings 316, 312.

In FIG. 6A, it can be seen that the first pivot point 308 is positioned in the enlarged end portion 318 of the second arcuate opening 316, while the second pivot point 310 is positioned away from the enlarged end portion 314 of the first arcuate opening 312. Accordingly, when the blade 304 is moved away from the closed position shown in FIG. 6A, it rotates on the first pivot point while the second pivot point 310 slides in the first arcuate opening 312, as shown in FIG. 6B. Movement of the blade 304 is easily accomplished by a user by pressing inward (towards liner 306) on the flipper 322.

Referring now to FIG. 6C, the blade has been moved approximately halfway from the closed position, as shown in FIG. 6A, toward the open position. The second pivot point 310 has entered the enlarged end portion 314 of the first arcuate opening 312, and the blade 304 cannot rotate further on the first pivot point 308. However, at this point in the rotation, the first pivot point 308 is now aligned with the second arcuate opening 316 so that, as the blade is moved further toward the open position, the blade 304 smoothly transitions to rotation around the second pivot point 310 while the first pivot point 308 slides in the second arcuate opening 316, as shown in FIG. 6D. Finally, when the blade 304 fully reaches the open position, as pictured in FIG. 6E, the first pivot point 308 contacts the extreme end of the second arcuate opening 316, which limits further rotation, and the liner lock 326 engages the tang of the blade 304, locking it in the open position.

By comparing FIGS. 6A and 6E, it can be seen that the enlarged end portion 318 of the second arcuate opening 316, which engages the first pivot point 308 while in the closed position, is moved outward from the handle 302 when the blade 304 is in the open position. In moving from the closed to the open position, the blade 304 has also moved this distance outward, and thus is lengthened accordingly.

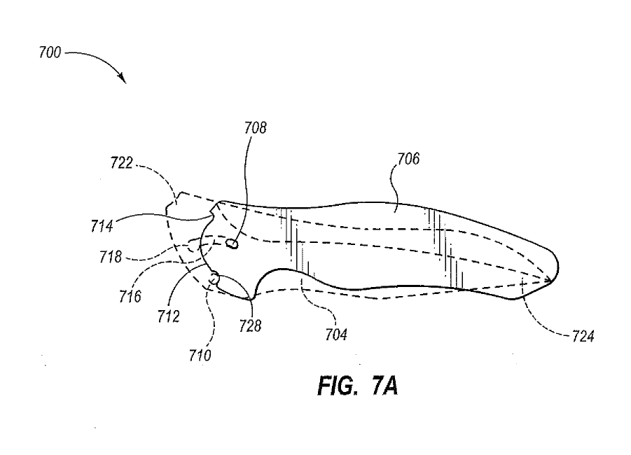

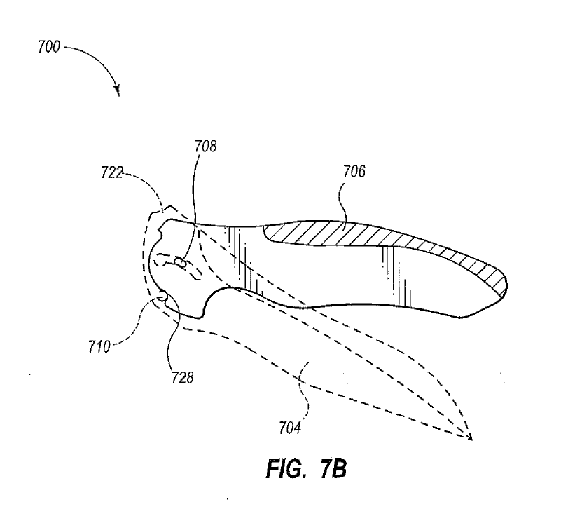

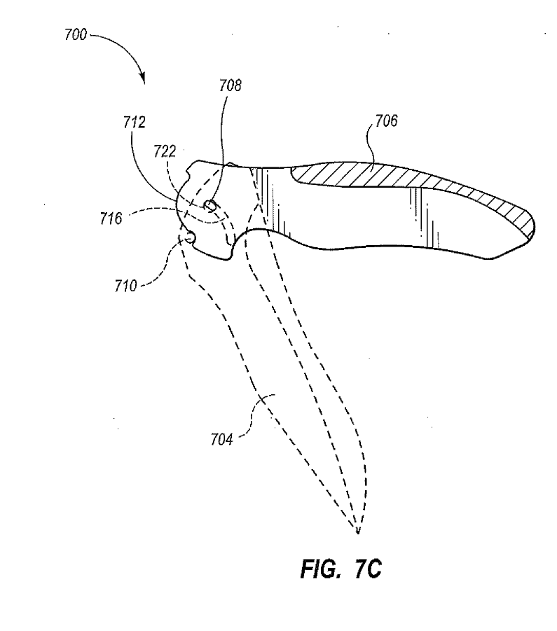

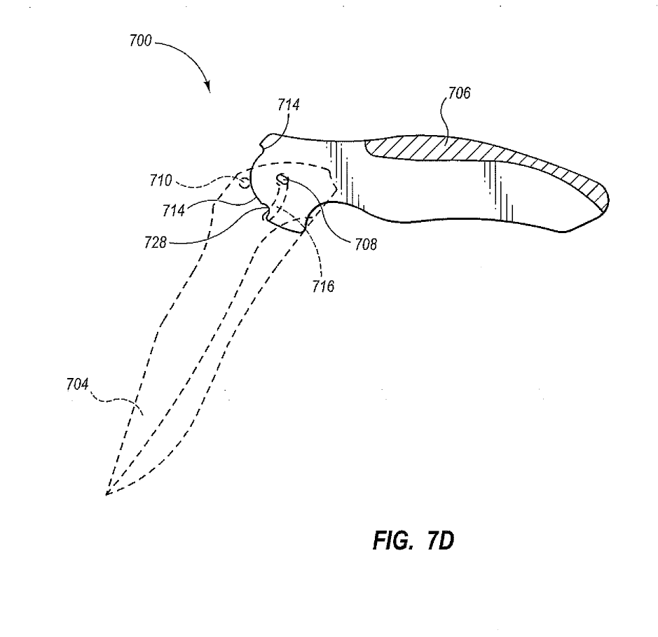

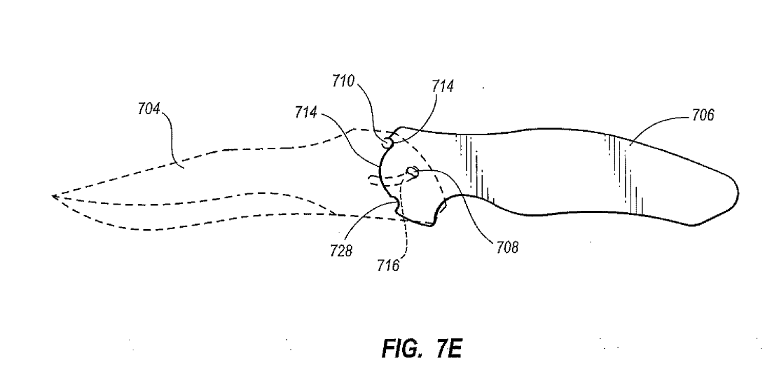

A knife 700 according to another embodiment of the invention, is illustrated with reference to FIGS. 7A-7E. Because of the different structure of this embodiment, reference number are given 7xx prefixes. However, apart from the new prefixes, the numbers indicate the same or equivalent elements.

In this embodiment, the second pivot point 710 is positioned outside the handle, and so, while functioning as a pivot point, it also can function as a thumb stud and/or a stop pin. Accordingly, the end of the liner 706 (and associated handle 712), has an arcuate shape to function as described previously with reference to the first arcuate opening 312. Features 714, 728 of the end portion 712 of the handle serve to limit travel of the pivot point 710. In this embodiment, only the first pivot point 708 is “keyed,” i.e., shaped to limit movement within the second arcuate opening 716, to prevent rotation except while in th enlarged end portion 718.

An examination of FIGS. 7A-7E will show that in this embodiment the blade 704 rotates first on the second pivot pin 710 while the first pivot point 708 slides in the second arcuate opening 716, then rotates on the first pivot point 708 when the second pivot pin reaches the end feature 714 of the liner 706 and the first pivot point 708 reaches the enlarged end portion 718 of the second arcuate opening 716, as shown in FIG. 7C.

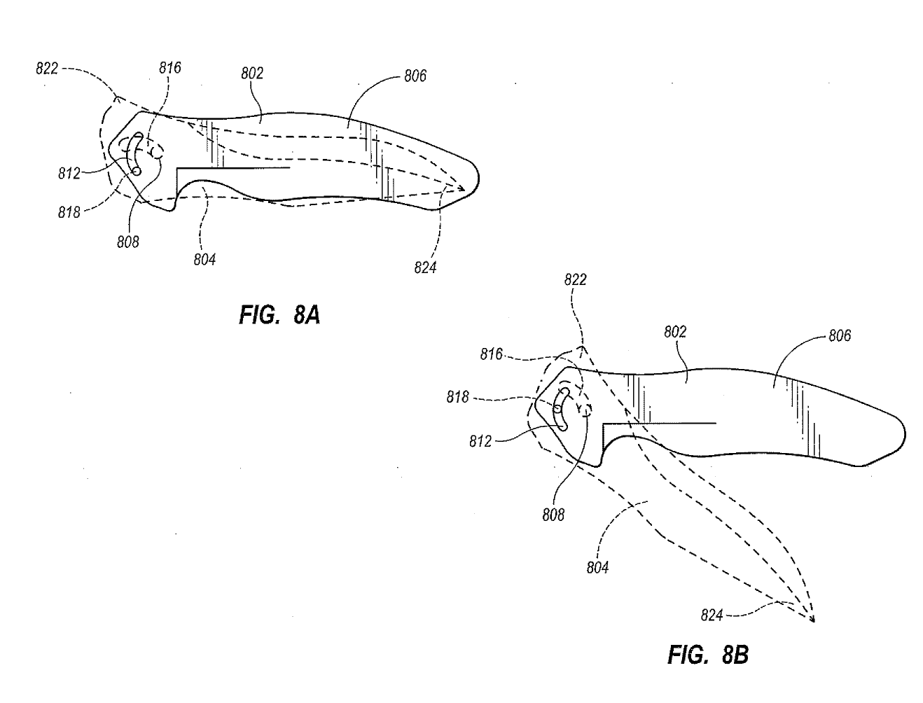

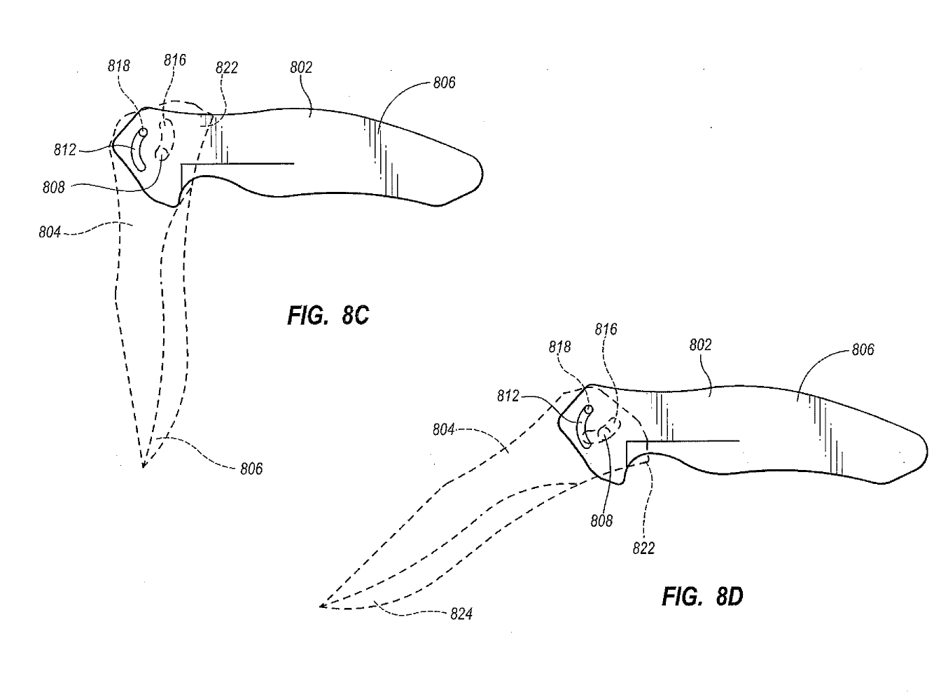

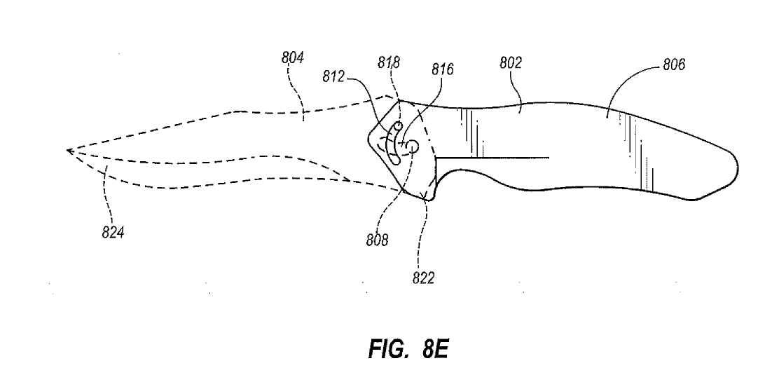

Referring now to the embodiment of FIGS. 8A-8E, another embodiment is disclosed in which the first and second pivot points 808, 818 are both round, and the first and second arcuate openings 812, 816 are without enlarged portions. The opening sequence depicted in the figures shows the blade pivoting on the first pivot point 808, then the second pivot point 818. However, in this embodiment, because there is no keying of either pivot point, the blade may pivot on either pivot point, or both pivot points simultaneously.

FIGS. 9A-9E show a knife 900 according to a further embodiment of the invention. It can be seen that each of the first and second arcuate openings 912, 916 includes an extension 920, 924, such that, when the blade 904 has been fully rotated toward the open position, as shown in FIG. 9E, it can then extend further outward the length of the extension, such that the lengthening of the blade 904 during extension is further increased.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A folding knife, comprising:
a handle;
and a blade;
the handle having a pivot point extending from the handle, and an arcuate opening having an axis approximately perpendicular to the longitudinal axis of the handle, for slidably receiving a pivot point extending from the blade; and
the blade having a pivot point extending from the blade, and an arcuate opening having an axis approximately parallel to the longitudinal axis of the blade, for slidably receiving the pivot point extending from the handle.

2. The folding knife of claim 1 wherein the arcuate opening in the blade has an enlarged end opening.

3. The folding knife of claim 1 wherein the arcuate opening in the handle has an enlarged end opening.

4. The folding knife of claim 1 wherein the arcuate opening in the blade has an extension at an end.

5. The folding knife of claim 4 wherein the extension is linear.

6. The folding knife of claim 5 wherein the linear extension is not approximately parallel to the arcuate opening in the blade.

7. The folding knife of claim 1 wherein the arcuate opening in the handle has an extension at an end.

8. The folding knife of claim 7 wherein the extension is linear.

9. The folding knife of claim 8 wherein the linear extension is not approximately parallel to the arcuate opening in the blade

10. A folding knife, comprising:
a handle;
and a blade;
the handle having a pivot point extending from the handle, and the end opposite the heel shaped in an arc having an axis approximately perpendicular to the longitudinal axis of the handle, for slidably receiving a pivot point extending from the blade; and
the blade having a pivot point extending from the blade, and an arcuate opening having an axis approximately parallel to the longitudinal axis of the blade, for slidably receiving the pivot point extending from the handle.

11. The folding knife of claim 10 wherein the arcuate opening in the blade has an enlarged end opening.

12. A knife, comprising:
a handle; and
a blade coupled to the handle and configured to rotate about a plurality of axes between an open and a closed position.
